(19) United States
(12) Patent Application Publication
(10) Pub. No.: US 2015/0052534 A1
(43) Pub. Date: Feb. 19, 2015

(54) METHOD AND DEVICE FOR EXECUTING SCHEDULED TASKS, COMPUTER-READABLE STORAGE MEDIUM, GRAPHICAL USER INTERFACE AND MOBILE TERMINAL

(71) Applicant: TENCENT TECHNOLOGY (SHENZHEN) COMPANY LIMITED, Shenzhen (CN)

(72) Inventors: Qing WANG, Shenzhen (CN); Zhanghu LUO, Shenzhen (CN); Zefeng HUANG, Shenzhen (CN); Haoran GUO, Shenzhen (CN); Quanhao XIAO, Shenzhen (CN); Yixia YUAN, Shenzhen (CN); Jiashun SONG, Shenzhen (CN); Pengtao LI, Shenzhen (CN); Yunfeng DAI, Shenzhen (CN); Xunchang ZHAN, Shenzhen (CN); Chunyou LIN, Shenzhen (CN)

(21) Appl. No.: 14/518,828

(22) Filed: Oct. 20, 2014

Related U.S. Application Data
(63) Continuation of application No. PCT/CN2013/073082, filed on Mar. 22, 2013.

(30) Foreign Application Priority Data
Apr. 18, 2012 (CN) 201210114591.6

(51) Int. Cl. G06F 9/46; G06F 17/30; H04W 4/02

(52) U.S. Cl. CPC G06F 9/46; H04W 4/02; G06F 17/30241
USPC 718/102

(57) ABSTRACT

A method and device for processing scheduled tasks. Computer readable storage medium, graphical user interface and mobile terminal are also provided. The method includes: acquiring current geographic location and current time of the mobile terminal; determining whether the current geographic location of the mobile terminal matches up to a trigger geographic location preset in the preset scheduled task; determining whether the current time of the mobile terminal matches up to a trigger time of the scheduled task; triggering the mobile terminal to execute the scheduled task, if the geographic location of the mobile terminal matches up to the trigger geographic location and the current time of the mobile terminal matches up to the trigger time of the scheduled task. By determining whether the current geographic location of the mobile terminal matches up to the trigger geographic location of the scheduled task and whether the current time of the mobile terminal matches up to the trigger time of the scheduled task and then to execute the scheduled task, it solves the complex problem that the user has to repeatedly set scheduled tasks in different locations so the mobile terminal can execute the scheduled task according to the current geographic location and time of the user.

### CROSS REFERENCE TO RELATED APPLICATIONS

This application is a continuation of International Patent Application No. PCT/CN2013/073082, filed on Mar. 22, 2013, which claims priority to Chinese Patent Application No. 201210114591.6, filed on Apr. 18, 2012, entitled “Method and Device for executing Scheduled Tasks”, the entire contents of both of said applications are incorporated herein by reference.

### TECHNICAL FIELD

The present disclosure relates to digital data processing technology, particularly to a method and device for executing scheduled tasks, computer readable storage medium, graphical user interface and mobile terminal.

### BACKGROUND

The scheduled task application programs (APP) is a kind of apps most widely used in people's daily life, such as schedule reminder, process management and alarm clock, particularly in the portable mobile terminal. The scheduled task generally comprises a trigger time and task content. That is, the scheduled task is an event to execute the task content on the trigger time.

The scheduled task execution method generally used in the mobile terminal with existing technology executes as follows: firstly receiving the trigger time and task content set by the user, e.g., 6:30 as the trigger time and alarm clock as the task content; then accordingly creating a scheduled task, e.g., setting the trigger time at 6:30 and alarm clock as the task content; finally executing the task content on the trigger time, e.g., the alarm clock is executed at 6:30.

During the present invention's realization, the inventor finds following problems with existing technology:

The user may often be in diverse geographical locations for the mobility of the mobile terminal, which makes the user accordingly set different scheduled tasks. Take the smartphone for example, the user sets two scheduled tasks in his smartphone while working in the enterprise, a rise alarm at 6:30 and a nap alarm at 13:30. When the user takes a business trip to the company's division office, he has to close the previous two tasks in his smartphone and sets a third one, that is, another rise alarm at 6:00. If the user's work involves a lot of business trips, it will be very cumbersome for him to set tasks repeatedly.

### SUMMARY

To solve the cumbersome problem that the user repeatedly sets tasks in business trips or different geographical locations, an embodiment of the present disclosure provides a method and device for executing scheduled tasks, computer-readable storage medium, graphical user interface and mobile terminal. The technical scheme of the present disclosure will be discussed hereinafter.

According to an example of the present disclosure, a method for executing scheduled tasks includes:

acquiring current geographical location and time of a mobile terminal;

determining whether the current geographical location of the mobile terminal matches up to a trigger geographic location preset in a scheduled task;

determining whether the current time of the mobile terminal matches up to a trigger time of the scheduled task; and

triggering the mobile terminal to execute the scheduled task on condition that the current geographical location of the mobile terminal matches up to the trigger geographic location and the current time of the mobile terminal matches up to the trigger time of the scheduled task.

The method may further include the following steps before determining whether the current geographic location of the mobile terminal matches up to the trigger geographic location preset in the scheduled task and whether the current time of the mobile terminal matches up to the trigger time of the preset scheduled task: presetting the scheduled task; wherein the scheduled task includes the trigger geographic location, the trigger time and task content.

Accordingly triggering the mobile terminal to execute the scheduled task includes: triggering the mobile terminal to execute the task content of the scheduled task.

Further the step of determining whether the current time of the mobile terminal matches up to a trigger time of the scheduled task includes:

judging whether the current time of the mobile terminal is the time in a time zone where the current geographic location of the mobile terminal is;

converting the current time of the mobile terminal to the time in the time zone where the current geographic location of the mobile terminal is on condition that they are not the same;

determining whether the current time after being converted matches up to a trigger time in the scheduled task.

The trigger geographic location is preset by the following steps: acquiring the trigger geographic location of the scheduled task in one of the following ways, receiving a geographic location triggered by the user in a map provided in the mobile terminal, acquiring the trigger geographic location via text information input by the user, or acquiring the current geographic location of the mobile terminal.

Acquiring the current geographic location of the mobile terminal includes: acquiring the current geographic location of the user through at least one of the following methods: positioning by GPS, positioning through the gateway of the current WIFI, positioning through the gateway of the current mobile network, and positioning via the base station of the current mobile network.

According to another example of the present disclosure, a device for executing scheduled tasks is also provided. The device includes:

a location acquisition module, configured to acquire current geographic location of a mobile terminal;

a time acquisition module, configured to acquire current time of the mobile terminal;

a Location comparison module, configured to determine whether the current geographical location of the mobile terminal matches up to a geographic trigger location of a scheduled task;

a time comparison module, configured to determine whether the current time of the mobile terminal matches up to a trigger time of the scheduled task; and

a task execution module, configured to trigger the mobile terminal to execute the scheduled task on condition that the current geographical location of the mobile terminal matches up to the trigger geographic location and the current time of the mobile terminal matches up to the trigger time of the scheduled task.

The schedule task execution device may further include: a task creation module, configured to preset the scheduled task; wherein the scheduled task includes the trigger geographic location, the trigger time and task content.

Correspondingly, the task execution module is configured to trigger the mobile terminal to execute the task content of the scheduled task.

The time comparison module includes:

a time zone judgment subunit, a time conversion subunit and a time matching subunit;

the time zone judgment subunit is configured to judge whether the current time of the mobile terminal is the time in a time zone where the current geographic location of the mobile terminal is;

the time conversion subunit is configured to convert the current time of the mobile terminal to the time in the time zone where the current geographic location of the mobile terminal is on condition that they are not the same; and

the time matching subunit is configured to determine whether the current time after being converted matches up to a trigger time in the scheduled task;

Further, the task creation module includes at least one of the following units: a first location set unit, a second location set unit and a third location set unit.

The first location set unit takes the geographic location triggered by the user on the map provided by the mobile terminal as the trigger geographic location of the scheduled task.

The second location set unit acquires the trigger geographic location of the scheduled task through the text information input by the user.

The third location set unit acquires the current geographic location of the mobile terminal as the trigger geographic location of the scheduled task.

Further, the location acquisition module includes at least one of the following units: a GPS (the global positioning system) positioning unit, a WIFI (wireless broadband) positioning unit, a mobile network positioning unit and a base station positioning unit.

The GPS positioning unit acquires the current geographic location of the user by GPS positioning.

The WIFI positioning unit acquires the current geographic location of the user by positioning through a gateway of a WIFI accessed.

The mobile network positioning unit acquires the current geographic location of the user by positioning through a gateway of a mobile network accessed.

The base station positioning unit acquires the current geographic location of the user by positioning through a base station of a mobile network accessed.

A mobile terminal is also provided, including a display, one or more processors, a memory and one or more programs, herein the one or more programs are stored in the memory, installed by the one or more processors to execute the following instructions:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

Further, the one or more programs include the following instructions: presetting the scheduled task; wherein the scheduled task includes the trigger geographic location, the trigger time and task content.

Accordingly triggering the mobile terminal to execute the scheduled task includes: triggering the mobile terminal to execute the task content of the scheduled task.

Further, the one or more programs include the following operating instructions:

judging whether the current time of the mobile terminal is the time in a time zone where the current geographic location of the mobile terminal is;

converting the current time of the mobile terminal to the time in the time zone where the current geographic location of the mobile terminal is on condition that they are not the same;

determining whether the current time after being converted matches up to a trigger time in the scheduled task.

Further, the one or more programs include the following instructions: acquiring the trigger geographic location of the scheduled task in one of the following ways, receiving a geographic location triggered by the user in a map provided in the mobile terminal, acquiring the trigger geographic location via text information input by the user, or acquiring the current geographic location of the mobile terminal.

Further, the one or more programs include the following instructions: acquiring the current geographic location of the user through at least one of the following methods: positioning by GPS, positioning through the gateway of the current WIFI, positioning through the gateway of the current mobile network, and positioning via the base station of the current mobile network.

A computer-readable storage medium is also provided, which includes one or more programs to execute a scheduled task execution method by one or more processors, including:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

The method may further include the following steps before determining whether the current geographic location of the mobile terminal matches up to the trigger geographic location preset in the scheduled task and whether the current time of the mobile terminal matches up to the trigger time of the preset scheduled task: presetting the scheduled task; wherein the scheduled task includes the trigger geographic location, the trigger time and task content.

Accordingly triggering the mobile terminal to execute the scheduled task includes: triggering the mobile terminal to execute the task content of the scheduled task.

Further the step of determining whether the current time of the mobile terminal matches up to a trigger time of the scheduled task includes:

judging whether the current time of the mobile terminal is the time in a time zone where the current geographic location of the mobile terminal is;

converting the current time of the mobile terminal to the time in the time zone where the current geographic location of the mobile terminal is on condition that they are not the same;

determining whether the current time after being converted matches up to a trigger time in the scheduled task.

The trigger geographic location is preset by the following steps: acquiring the trigger geographic location of the scheduled task in one of the following ways, receiving a geographic location triggered by the user in a map provided in the mobile terminal, acquiring the trigger geographic location via text information input by the user, or acquiring the current geographic location of the mobile terminal.

The step of acquiring the current geographic location of the mobile terminal includes: acquiring the current geographic location of the user through at least one of the following methods: positioning by GPS, positioning through the gateway of the current WIFI, positioning through the gateway of the current mobile network, and positioning via the base station of the current mobile network.

A graphical user interface is also provided in the mobile terminal which includes a touch-screen display, a memory and one or more processors to execute one or more programs, including:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

The technical scheme provided in the embodiments of the present disclosure can make benefits as follows: by comparing whether the current geographic location of the mobile terminal matches up to the trigger geographic location of the scheduled task and whether the current time of the mobile terminal matches up to the trigger time of the scheduled task and then to execute the scheduled task, it solves the complex problem that the user has to repeatedly set scheduled tasks in different locations so the mobile terminal can execute the scheduled task according to the current geographic location and time of the user.

### BRIEF DESCRIPTION OF THE DRAWINGS

In order to explain the technical scheme in the embodiment of the present disclosure more clearly, brief illustration will be made for the figures. Obviously, following figures in the illustration are of some embodiments of the present invention, and the ordinary skilled in the art can obtain other figures through these figures without any creative labor.

FIG. 1 is a flow diagram of a method executing scheduled tasks according to a first embodiment of the present disclosure;

FIG. 2 is a flow diagram of a method executing scheduled tasks according to a second embodiment of the present disclosure;

FIG. 3A is a diagram of a mode of setting a trigger time according to the second embodiment of the present disclosure;

FIG. 3B is another diagram of a mode of setting a trigger time according to the second embodiment of the present disclosure;

FIG. 4 is a block diagram of a device executing a scheduled task according to a third embodiment of the present disclosure;

FIG. 5 is another block diagram of a device executing a scheduled task according to a third embodiment of the present disclosure;

FIG. 6 is a block diagram of the task creation module according to a third embodiment of the present disclosure;

FIG. 7 is a block diagram of the time comparison module according to a third embodiment of the present disclosure;

FIG. 8 is a block diagram of the location acquisition module according to a third embodiment of the present disclosure; and

FIG. 9 is a block diagram illustrating the structure of a mobile terminal according to a third embodiment of the present disclosure.

### DETAILED DESCRIPTION

To make the objective, technical solutions and advantages of the present invention clearer, examples of the present invention would be described in further detail with reference to the drawings.

### A First Embodiment

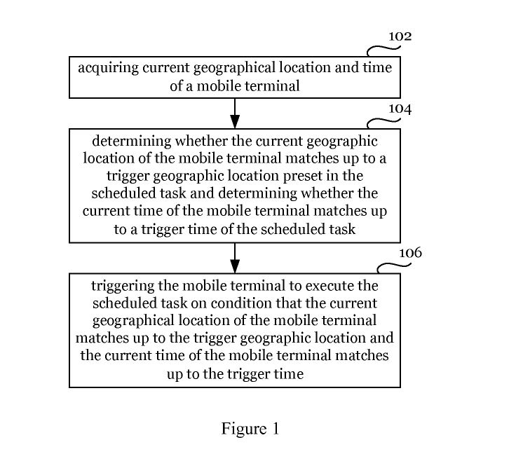

Please refer to FIG. 1, which depicts a flow diagram of a method for executing scheduled tasks according to a first embodiment of the present disclosure, which can be executed in a mobile terminal such as a laptop, tablet and smartphone. The method includes the following steps.

Step 102, acquiring current geographical location and time of a mobile terminal.

Take the smartphone for example, the smartphone can obtain its own current geographic location in preset method with latitude-longitude identification. A preset method acquiring its current geographic location is to real-time position by Global Positioning System (GPS) and to acquire its current geographic location. Meanwhile, the smartphone can get the time of the system, the time indicated from the text information input by the user, or the time set by the user on the set disk as its own current time. This embodiment never limits the method to acquire the current geographic location and time of the mobile terminal.

Step 104, determining whether the current geographic location of the mobile terminal matches up to a trigger geographic location preset in the scheduled task and determining whether the current time of the mobile terminal matches up to a trigger time of the scheduled task.

The smartphone can save the scheduled tasks preset. The scheduled task may include the trigger geographic location and task content. E.g., the Capital International Airport can be set as the trigger geographic location and an operation of shutdown can be set as the task content. While acquiring its own current geographic location, the smartphone can determine whether the current geographic location matches up to the trigger geographic location preset in the scheduled task.

Besides the trigger geographic location and the task content, the preset scheduled task also includes the trigger time, which can be the time indicated from the text information input by the user or the time selected by the user on the set disk. This embodiment never limits the method to set the trigger time. And after acquiring the current time, the smartphone may determine whether the current time matches up to the trigger time of the scheduled task.

Specifically, the terminal may firstly determine whether the current geographic location of the mobile terminal matches up to the trigger geographic location preset in the scheduled task and determine whether the current time of the mobile terminal matches up to the trigger time preset by the scheduled task, or just converse the order, and this embodiment never limits the order of the two executions.

Step 106, triggering the mobile terminal to execute the scheduled task on condition that the current geographical location of the mobile terminal matches up to the trigger geographic location and the current time of the mobile terminal matches up to the trigger time of the scheduled task.

If the comparison result shows that the current geographic location of the smartphone matches up to the trigger geographic location of the scheduled task and the current time of the smartphone matches up to the trigger time of the scheduled task, the smartphone will execute the scheduled task. E.g., once the smartphone has confirmed that its own current geographic location is the Capital International Airport and it matches up to the trigger geographic location of the scheduled task, the smartphone will made shutdown execution. This embodiment never limits the concrete task contents of the scheduled task, which can change to any kind, such as switching to the interception mode, switching to the profiles mode, reminder notes, ringing alarm clock, shutdown and restart.

In a word, the scheduled task execution method according to the first embodiment of the present disclosure is, to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its own current geographic location and time.

### A Second Embodiment

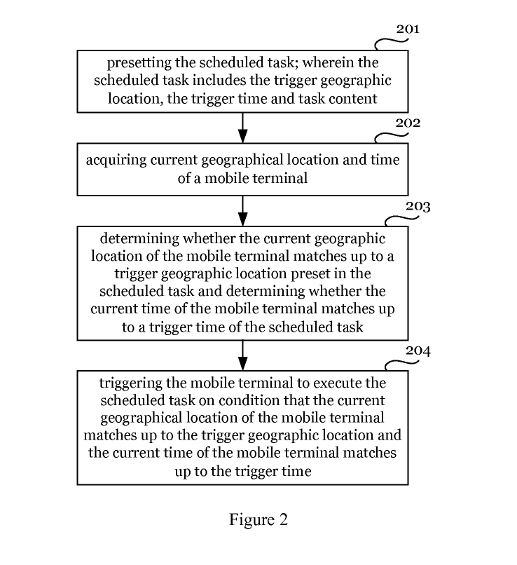

Please refer to FIG. 2, which depicts a flow diagram of a method for executing scheduled tasks according to a second embodiment of the present disclosure, which can be executed in a mobile terminal such as a laptop, tablet and smartphone. The method includes the following steps.

Step 201, presetting the scheduled task; wherein the scheduled task includes the trigger geographic location, the trigger time and task content.

The scheduled task in this embodiment includes the trigger geographic location, trigger time and task content, which can be created by the mobile terminal, or created by the server and transferred to the mobile terminal, but mostly manually created by the user of the mobile terminal.

Still take the smartphone for example. Creating the scheduled task by the user of the mobile terminal usually includes: firstly the trigger geographic location, trigger time and task content of the scheduled task are input by the user, which then are received by the smartphone and the smartphone may accordingly create a scheduled task.

Specifically, the smartphone may create the trigger geographic location of the scheduled task in any way as follows:

First, the mobile terminal provides a map, and takes the geographic location triggered by the user on the map as the trigger geographic location of the scheduled task.

The smartphone can provide a map to the user, and the user can operate the smartphone into the map page and confirm a desired trigger geographic location. Take the touchscreen smartphone for example. The smartphone provides a map on the touchscreen, and the user slides his finger to change the map position, contract or expand his finger to change the map scale, select the desired geographic location in the map, and the smartphone can take the geographic location as the trigger geographic location.

Second, acquire the geographic location indicated from text information input by the user and take the acquired geographic location as the trigger geographic location of the scheduled task.

The user can directly input the text information of the desired geographic location in the smartphone. E.g., if the user needs the Tiananmen Square as the trigger geographic location, he can input the words “Tiananmen Square” in the dialog box when the smartphone enters the setting interface for the trigger geographic location, and the smartphone will take the geographic location indicated from the text information as the trigger geographic location.

Third, acquire the current geographic location of the mobile terminal and tack the current geographic location as the trigger geographic location of the scheduled task.

When the user doesn't need to set the geographic location or the user wants to set the current geographic location of the smartphone as the trigger geographic location, the user needn't operate, or chooses the “the current geographic location” in the dialog box of the trigger geographic location and the smartphone can acquire its current geographic location through a preset method and take the current geographic location as the trigger geographic location of the scheduled task.

Herein on the other hand, the smartphone can create the trigger time of the scheduled task in any way as follows:

First, acquire the trigger time via the text information input by the user.

The user can directly input the text information in the smartphone what trigger time he needs. E.g., the user enters the interface of the trigger time where the dialog box will be shown on the touchscreen, then the user can directly input the text information such as 8:00 or 5:00 in the dialog box, and the smartphone will take the time indicated from the text information as the

Second, take the time set by the user on the set disk as the trigger time.

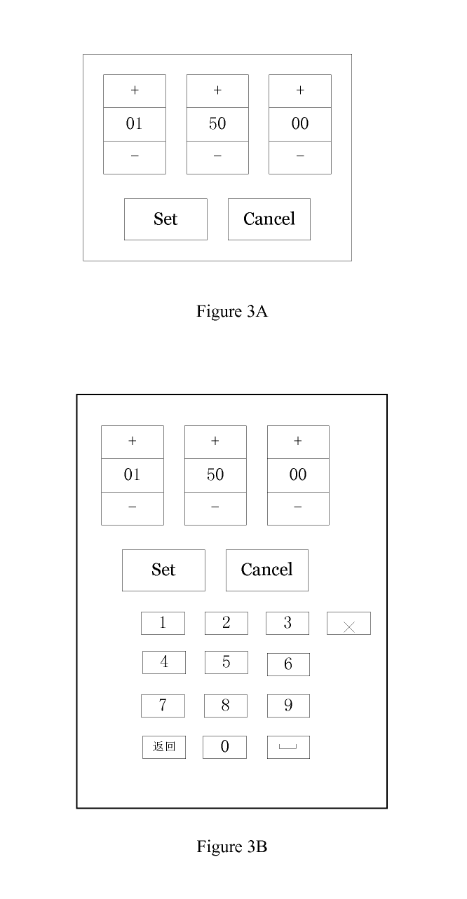

If the user needs, he can set the number of hour, minute and second respectively through digital change on the set disk of the smartphone, and the smartphone will take the time indicated on the set disk as the trigger time. As shown in FIG. 3A, when the user wants to set the trigger time at 8:30:00, he can enter the setting interface of the trigger time in the smartphone where the initial data 1:50:00 is shown on the touchscreen, set the data in three steps on the touchscreen as follows: first changing the hour disk from 1 to 8, then changing the minute disk from 50 to 30, and making no change on the second disk.

Or as shown in FIG. 3B, the user can select the number of hour 01 and directly input 08 on the interface, and set the minute disk to 30 and the second disk to 00 in the same way, finally set the data at 8:30:00.

Third, take the indicated time that is equal to the time when the current geographic location matches up to the trigger geographic location to a fixed length as the trigger time.

The smartphone can receive a fixed length of time input by the user and take the indicated time that is equal to the time when the current geographic location matches up to the trigger geographic location to a fixed length as the trigger time. That is, when the fixed length is set as 3 second by the user, if the smartphone confirms that the current geographic location matches up to the trigger geographic location, then 3 seconds later the smartphone will execute the task content. The fixed length of time can also be the data set by the system such as 5 minutes. E.g., the trigger location is the airport, when the smartphone confirms that the current geographic location matches up to the trigger geographic location and it will execute the scheduled task to shutdown 5 minutes later. The fixed length of time can certainly be 0.

This embodiment never limits the concrete task contents of the scheduled task, which can change to any kind such as switching to the interception mode, switching to the profiles mode, reminder notes, ringing alarm clock, shutdown or restart.

To be noted, the trigger time of the scheduled task in the smartphone is usually based on the time in the time zone where the trigger geographic location is. That is, if the user set a scheduled task comprising Beijing as the trigger geographic location, 8:00 as the trigger time and alarm clock as the task content, the trigger time is Beijing time 8:00.

Step 202, acquiring current geographical location and time of a mobile terminal.

Once the scheduled task has been created, the smartphone can acquire the current geographic location at predetermined intervals. The scheduled interval can be a fixed time set by the smartphone such as 3 seconds or a fixed time manually set by the user such as 10 minutes or 1 second. E.g., if the current geographic location is Shenzhen city and the trigger geographic location is Tiananmen Square, the user can manually set a relatively large number as the fixed internal, such as 10 minutes. If the current geographic location is A residential community in Shenzhen and the trigger geographic location is B residential community in Shenzhen, the user can manually set a relatively small number as the fixed internal, such as 2 seconds.

Meanwhile, the smartphone can acquire the current geographic location through any preset method as follows: positioning by GPS, positioning through the gateway of the WIFI, positioning through the gateway of the mobile network, or positioning via the base station of the mobile network.

Step 203, determining whether the current geographic location of the mobile terminal matches up to a trigger geographic location preset in the scheduled task and determining whether the current time of the mobile terminal matches up to a trigger time of the scheduled task;

While acquiring its own current geographic location, the smartphone can determine whether the current geographic location matches up to the trigger geographic location preset in the scheduled task. The geographic location is usually indicated with latitude-longitude. Therefore, according to their respective latitudes and longitudes, the smartphone can judge the distance between its current geographic location and the trigger geographic location, that is, judge whether the distance between the current geographic location and the trigger geographic location is less than a preset threshold. Herein the scheduled threshold can be a fixed data preset by the system such as 1000 meters, or a numerical value manually set by the user such as 500 meters. When the distance is less than the scheduled threshold, the smartphone confirms that the current geographic location matches up to the trigger geographic location.

Certainly, the scheduled task in the embodiment includes the trigger geographic location, the trigger time and the task content, and Step 203 should also include as follows: determining whether the current time of the mobile terminal matches up to the trigger time of the scheduled task, if the answer is positive, the task content should be executed. E.g., the scheduled task is to set the geographic location where the company is as the trigger geographic location, 9:00 as the trigger time and switching profiles to silent as the task content, and the smartphone firstly compares the current geographic location with the trigger geographic location and confirms the current geographic location matches up to the trigger geographic location, then compares the current time with the trigger time of the scheduled task, if the current time matches up to the trigger time of the scheduled task, takes the execution of switching profiles to silent.

Herein it should be considered during setting the scheduled task the geographic location of the smartphone and the trigger geographic location of the scheduled task may be in different time zones. E.g., the user sets the scheduled task in Beijing and the time in the smartphone is shown and identified as Beijing time, meanwhile the user set a scheduled task comprising Tokyo as the trigger geographic location and 8:00 as the trigger time; when the user flies to Tokyo the time in his smartphone is still Beijing time, however the user wants to trigger the task at Tokyo time 8:00. Therefore, the smartphone confirms that the current geographic location of the smartphone matches up to the trigger geographic location, and compares later whether the current time of the mobile terminal matches up to the trigger time of the scheduled task, further including:

First, judging whether the current time of the mobile terminal is the time in a time zone where the current geographic location of the mobile terminal is.

E.g., the current time of the smartphone is Beijing time 8:20, and the current geographic location of the smartphone is Tokyo, and the smartphone should judge whether Beijing time 8:20 is the time in the time zone where Tokyo is.

Second, converting the current time of the mobile terminal to the time in the time zone where the current geographic location of the mobile terminal is on condition that they are not the same.

The smartphone can confirm that the Beijing time 8:20 isn't the Tokyo time, and convert the Beijing time 8:20 to the Tokyo time 7:20, because Beijing is GMT+8 while Tokyo is GMT+9 and the Tokyo time is one hour earlier than the Beijing time.

Third, determining whether the current time after being converted matches up to a trigger time in the scheduled task.

The smartphone determines whether the current time after conversion matches up to the trigger time of the scheduled task, if they are matched, the task content will be executed and vice versa.

Step 204, triggering the mobile terminal to execute the scheduled task on condition that the current geographical location of the mobile terminal matches up to the trigger geographic location and the current time of the mobile terminal matches up to the trigger time of the scheduled task.

If the comparison result shows that the current geographic location of the smartphone matches up to the trigger geographic location of the scheduled task and the current time of the smartphone matches up to the trigger time of the scheduled task, the smartphone will execute the scheduled task. E.g., the scheduled task sets the Capital International Airport as the trigger geographic location and shutdown as the task content, and the smartphone will execute shutdown if it confirms the geographic location of the smartphone is the Capital International Airport which matches up to the trigger geographic location of the scheduled task meanwhile the current time matches up to the trigger time of the scheduled task.

In conclusion, the scheduled task execution method in the second embodiment of the present disclosure is, to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its current geographic location and time. Besides, the mobile terminal precisely matches the trigger time in accordance with the time difference of time zones between the trigger geographic location and the current geographic location of the user, which avoids the problem that an inaccurate trigger time caused by the time difference leads to an inaccurate trigger task.

### A Third Embodiment

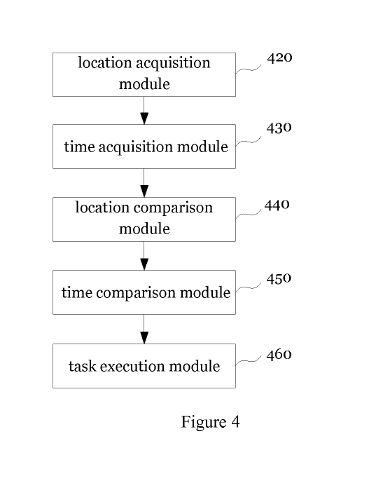

FIG. 4 shows a block diagram of a device executing the scheduled task according to a third embodiment of the present disclosure, which can be executed in a mobile terminal such as a laptop, tablet and smartphone, and the device comprises a location acquisition module 420, a time acquisition module 430, a location comparison module 440, a time comparison module 450 and a task execution module 460.

The location acquisition module 420 is configured to acquire current geographic location of a mobile terminal.

The time acquisition module 430 is configured to acquire current time of the mobile terminal.

The location comparison module 440 is configured to determine whether the current geographical location of the mobile terminal matches up to a geographic trigger location of a scheduled task.

The time comparison module 450 is configured to determine whether the current time of the mobile terminal matches up to a trigger time of the scheduled task.

The task execution module 460 is configured to trigger the mobile terminal to execute the scheduled task on condition that the current geographical location of the mobile terminal matches up to the trigger geographic location and the current time of the mobile terminal matches up to the trigger time of the scheduled task.

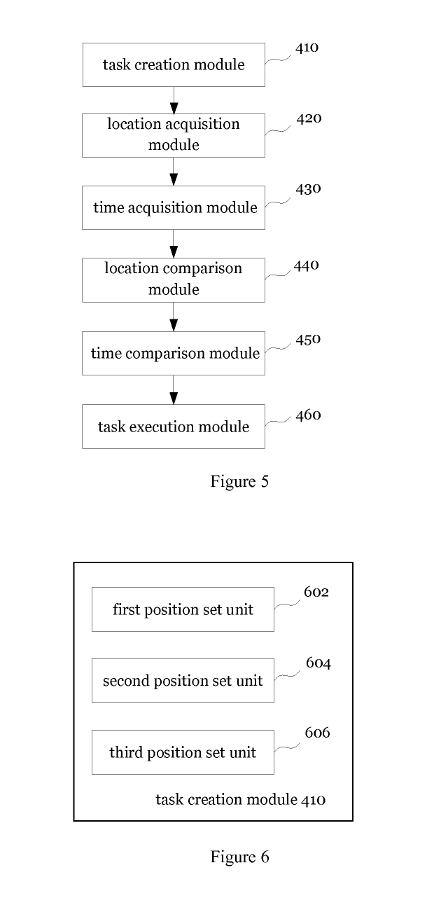

Preferably, the scheduled task execution device may also include a task creation module 410. As shown in FIG. 5, the task creation module 410 is configured to preset the scheduled task, the scheduled task comprising the trigger geographic location, the trigger time and the task content. As shown in FIG. 6, the task creation module 410 includes at least one of the following units: a first position set unit 602, a second position set unit 604 and a third position set unit 606. Herein, the first position set unit 602 is configured to take the geographic location triggered by the user in the map provided in the mobile terminal as the trigger geographic location of the scheduled task; the second position set unit 604 is configured to acquire the trigger geographic location of the scheduled task from the text information input by the user; the third position set unit 606 is configured to directly acquire the current geographic location of the mobile terminal and take the current geographic location as the trigger geographic location of the scheduled task.

Correspondingly, the task execution module 460 is configured to trigger the mobile terminal to execute the task content of the scheduled task.

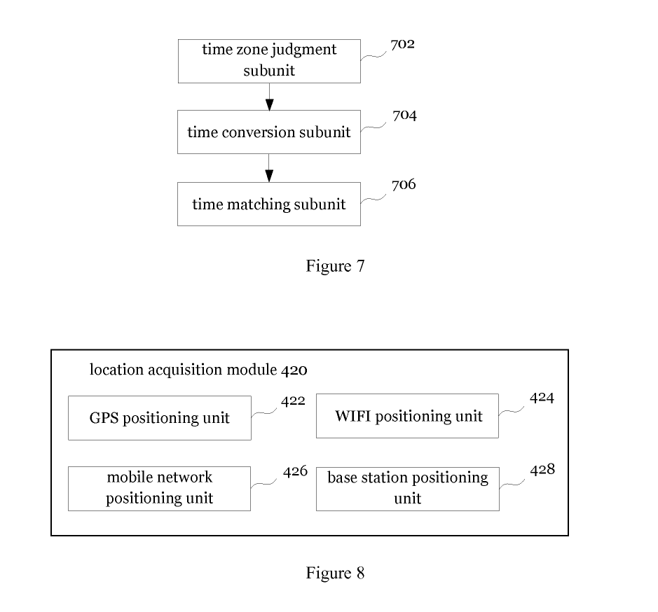

Preferably, as shown in FIG. 7, the time comparison module 450 includes a time zone judgment subunit 702, a time conversion subunit 704 and a time matching subunit 706. Herein, the time zone judgment subunit 702 is configured to judge whether the current time of the mobile terminal is the time in the time zone where the geographic location of the mobile terminal is; the time conversion subunit 704 is configured to convert the current time of the mobile terminal to the time in the time zone where the geographic location of the mobile terminal is, if the result of the time zone judgment subunit 702 is negative; the time matching subunit 706 is configured to determine whether the current time after above conversion matches up to the trigger time of the scheduled task.

Preferably, as shown in FIG. 8, the location acquisition module 420 includes at least one of the following units: a GPS positioning unit 422, a WIFI positioning unit 424, a mobile network positioning unit 426 and a base station positioning unit 428. Herein, the GPS positioning unit 422 is configured to acquire the current geographic location of the user by GPS positioning; the WIFI positioning unit 424 is configured to acquire the current geographic location of the user through positioning the gateway of the current WIFI; the mobile network positioning unit 426 is configured to acquire the current geographic location of the user through positioning the gateway of the current mobile network; and the base station positioning unit 428 is configured to acquire the current geographic location of the user through positioning the base station of the current mobile network.

In a word, the scheduled task execution method in the third embodiment of the present disclosure is, to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its current geographic location and time. Besides, the mobile terminal precisely matches the trigger time in accordance with the time difference of time zones between the trigger geographic location and the current geographic location of the user, which avoids the problem that an inaccurate trigger time caused by the time difference leads to an inaccurate trigger task.

### A Fourth Embodiment

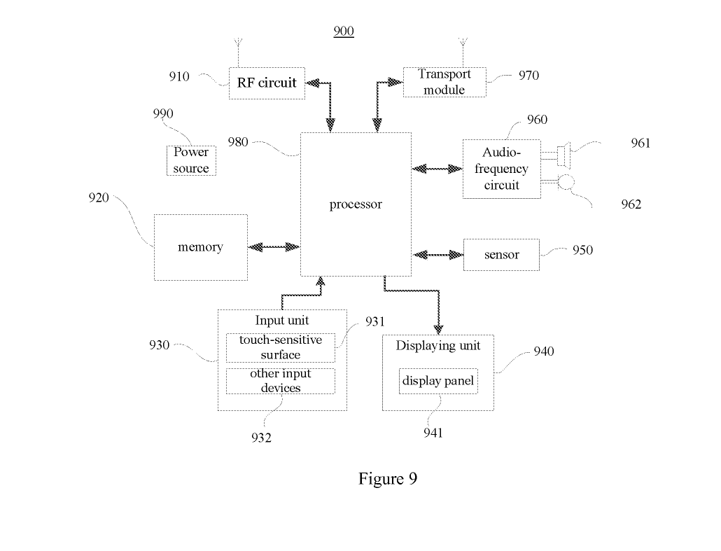

As shown in FIG. 9, a mobile terminal is provided in this embodiment and it includes a RF (Radio Frequency) circuit 910, a memory 920 with one or more computer readable storage medium, an input unit 930, a displaying unit 940, a sensor 950, an audio-frequency circuit 960, a transport module 970, a processor 980 with one or more processing cores and a power source 990, etc. The technological staff in the art can understand that the structural diagram of the mobile terminal in FIG. 9 makes no limitation to the mobile terminal which can include more or less components, assemble some components of them or make different component installation.

The RF circuit 910 is configured to receive information or receive and send signals during a call; especially, to receive downstream information from a base station, transfer it to one or more processor 980, and send upstream information to the base station. Usually, the RF circuit 910 includes but not limited to an antenna, at least an amplifier, a tuner, one or more oscillators, a subscriber identity module (SIM) card, a transceiver, a coupler, LNA (Low Noise Amplifier) and a duplexer, etc. Besides, the RF circuit 910 can communicate with the network and other devices through wireless communication. The wireless communication can use any communications standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), e-mail and SMS (Short Messaging Service) and etc.

The memory 920 is configured to store software programs and module which are controlled by the processor 980 to execute all functions and data processing. The memory 920 mainly includes program storage sector and data storage sector. Herein, the program storage sector can store operating systems and at least one application that a function requires such as displaying pictures and playing sound; and the data storage sector is to store data created during the execution of the mobile terminal 900, such as audio data and a phone book, etc. Besides, the memory 920 can include high-speed random access storage and nonvolatile memory, such as at least one disk storage device, a flash memory device or other nonvolatile solid state storage devices. The memory 920 can accordingly include a memory controller for the processor 980 and the input unit to access the memory 920.

The input unit 930 is configured to receive number or character information input and generate input signals from the keyboard, mouse, joystick, optical or trackball responded to the set and function control of the user. The input unit 930 can specifically include a touch-sensitive surface 931 and other input devices 932. The touch-sensitive surface 931, also called touch-sensitive display or touch pad, can collect the touch operations of the user on it, e.g., the operations of the user on or nearby the touch-sensitive surface 931 with any suitable object or accessory like the finger and the stylus, and drive the connecting device in accordance with the preset program. Optionally, the touch-sensitive surface 931 includes a touch detector and a touch controller. Herein, the touch detector is to detect the touch position of the user and the signal responding to the touch then to send the signal to the touch controller; the touch controller is to receive the signal touch information from the touch detector, to convert it to the contact coordinate, to send it to the processor 980 whose order is also received and executed. Besides, the touch-sensitive surface 931 can be achieved in the ways of resistance, capacitance, infrared rays and surface acoustic waves. The input unit 930 may also include other input devices 932 besides the touch-sensitive surface 931. Specifically, other input devices 932 may include but not limited to one or more of the physical keyboard, function keys like the volume control button and the on-off button, the trackball, the mouse and the lever.

The displaying unit 940 is configured to display the information input by the user, the information provided to the user and various graphics user interfaces of the mobile terminal which consist of graphics, texts, icons videos or any combination of them. The displaying unit 940 may include a display panel 941 that can be optionally configured of an LCD (Liquid Crystal Display), OLED (Organic Light-Emitting Diode) and etc. Moreover, the touch-sensitive surface 931 can cover the display panel 941. When the touch-sensitive surface 931 detects touch operations on or nearby it, transfers these operations to the processor 980 to confirm the type of the touch occurrence, and as soon as the type of the touch occurrence is confirmed the processor 980 makes the visual output accordingly on the display panel 941. The touch-sensitive surface 931 and the display panel 941 are two parts to achieve input and output separately in FIG. 9, but the touch-sensitive surface 931 and the display panel 941 can be integrated to execute input and output in some embodiments.

The mobile terminal 900 can also include at least one sensor 950, such as a light sensor, a motion sensor and other sensors. Herein the light sensor may include an environmental light sensor and a proximity sensor, and the former can brighten the display panel 941 in accordance with the light and darkness of the environment while the latter will shut down the display panel 941 or backlight when the mobile terminal 900 is moved to the ear. The Gravity acceleration sensor, a kind of motion sensor, can detect acceleration in every direction in a three-axis way or the force and direction of the gravity when still, recognize the application of the mobile gesture such as the switching between landscape and portrait, relevant games and the magnetometer calibration, and recognize relevant functions with vibrations such as the pedometer and hits, etc. The mobile terminal 900 can also install a gyroscope, a barometer, a hygrometer, a thermometer and an infrared sensor which will not be described in details here.

The audio-frequency circuit 960, a loudspeaker 961 and a microphone 962 provide an audio interface between the user and the mobile terminal. The audio-frequency circuit 960 can receive audio-frequency signals and convert them to electrical signals, which are transferred to and output as sound signals by the loudspeaker 961; on the other hand, the sound signals are collected and converted to electrical signals by the microphones 962, then collected and converted to the sound signals by the audio-frequency circuit 960, finally handled by the audio data output processor 980 and sent to another mobile terminal through RF circuit 910, or further handled to the memory 920 as the audio-frequency signals. The audio-frequency circuit 960 may also include an earplug jack to provide communications between a peripheral earphone and the mobile terminal 900.

WiFi (Wireless Fidelity) is a short-distance wireless transmission technology, and through the transport module 970 the mobile terminal 900 can help the user receive/send e-mails, browse the web and access the streaming media etc. and surf the broadband internet wirelessly. Understandably, the transport module 970 shown in FIG. 9 is not an essential part of the mobile terminal 900 and can be omitted with no fundamental change if necessary.

As a control center of the mobile terminal 900, a processor 980 connects all parts of the phone with wires and interfaces, executes all functions, processes data of the mobile terminal 900 and monitors the overall situation of the phone by executing or operating the software programs and or modules or calling the data stored in the memory 920. Optionally, the processor 980 can include one or more processing cores. Preferably, the processor 980 can integrate an application processor and a modem processor. Herein, the application processor is configured to execute operation systems, GUIs and application programs; and the modem processor is configured to establish wireless communications. To be noted, the modem processor can also be an independent part without being integrated in the processor 980.

The mobile terminal 900 may also include a power source 990 such as batteries. Preferably, the power source is logically connected with the processor 980 through a power management system thus to achieve the management of plugging, unplugging and power consumption, etc. The power source 990 also includes any subassembly as follows: one or more DC or AC powers, a recharging system, a power malfunction measure circuit, a power converter or inverter and a power status indicator, etc.

The mobile terminal 900 can also include webcams, a Bluetooth module and etc. which are not shown in FIG. 9 and will not be described in details herein this embodiment concretely, the displaying unit of the mobile terminal 900 can be a touch-screen display or a non-touch-screen display. The mobile terminal 900 can include a memory and one or more programs and the one or more programs are stored in the memory. In the first possible execution method one or more processors are installed to execute the operating instructions from one or more programs as follows:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

In combination with the first possible execution method, the memory of the mobile terminal also includes operating instructions as follows to execute in the second possible execution method: presetting the scheduled task; wherein the scheduled task includes the trigger geographic location, the trigger time and task content.

Accordingly the step of triggering the mobile terminal to execute the scheduled task includes: triggering the mobile terminal to execute the task content of the scheduled task.

The memory of the mobile terminal may also include operating instructions as follows to execute the third possible execution method.

The step of determining whether the current time of the mobile terminal matches up to a trigger time in the scheduled task includes:

first, judging whether the current time of the mobile terminal is the time in a time zone where the current geographic location of the mobile terminal is;

second, converting the current time of the mobile terminal to the time in the time zone where the current geographic location of the mobile terminal is on condition that the current time of the mobile terminal is not the time in a time zone where the current geographic location of the mobile terminal is;

determining whether the current time after being converted matches up to a trigger time in the scheduled task.

The memory of the mobile terminal may also include operating instructions as follows to execute the fourth possible execution method:

acquiring the trigger geographic location of the scheduled task in any following way, by taking the geographic location triggered by the user in the map provided in the mobile terminal as the trigger geographic location, from the text information input by the user, or directly acquiring the current geographic location of the mobile terminal.

The memory of the mobile terminal may also include operating instructions as follows to execute the fifth possible execution method:

acquiring the current geographic location of the user through at least one of the following methods: positioning by GPS, positioning through the gateway of WIFI, positioning through the gateway of the mobile network, and positioning via the base station of the mobile network.

In a word, the scheduled task execution method in the fourth embodiment of the present disclosure is, to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its current geographic location and time. Besides, the mobile terminal precisely matches the trigger time in accordance with the time difference of time zones between the trigger geographic location and the current geographic location of the user, which avoids the problem that an inaccurate trigger time caused by the time difference leads to an inaccurate trigger task.

### A Fifth Embodiment

The fifth embodiment of the present disclosure provides a computer readable storage medium, which can be comprised in memories in the above embodiments or separate and not assembled in the mobile terminal. The computer-readable storage medium may include one or more programs being executed by one or more processors to execute a scheduled task execution method by one or more processors, including:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

Assume that above is the first possible execution method and based on the first one, before determining whether the geographic location of the mobile terminal matches up to the trigger geographic location and whether the current time of the mobile terminal matches up to the trigger time of the scheduled task, the second possible execution method further includes as follows: presetting the scheduled task; wherein the scheduled task includes the trigger geographic location, the trigger time and task content.

Accordingly triggering the mobile terminal to execute the scheduled task includes: triggering the mobile terminal to execute the task content of the scheduled task.

In the third possible method based on the first one, the step of determining whether the current time of the mobile terminal matches up to the trigger time of the preset scheduled task may include:

judging whether the current time of the mobile terminal is the time in a time zone where the current geographic location of the mobile terminal is;

converting the current time of the mobile terminal to the time in the time zone where the current geographic location of the mobile terminal is on condition that they are not the same; and

determining whether the current time after being converted matches up to a trigger time in the scheduled task.

In the fourth possible execution method based on the second one, the trigger geographic location may be preset in the scheduled task by the following steps:

acquiring the trigger geographic location of the scheduled task in one of the following ways, receiving a geographic location triggered by the user in a map provided in the mobile terminal, acquiring the trigger geographic location via text information input by the user, or acquiring the current geographic location of the mobile terminal.

In the fifth possible execution method based on the first one, the second one, the third one or the fourth one, the step of acquiring the current geographic location of the mobile terminal may include:

acquiring the current geographic location of the user through at least one of the following methods: positioning by GPS, positioning through the gateway of the current WIFI, positioning through the gateway of the current mobile network, and positioning via the base station of the current mobile network.

In a word, the computer readable storage medium provided by the present disclosure is configured to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its current geographic location and time. Besides, the mobile terminal precisely matches the trigger time in accordance with the time difference of time zones between the trigger geographic location and the current geographic location of the user, which avoids the problem that an inaccurate trigger time caused by the time difference leads to an inaccurate trigger task.

### A Sixth Embodiment

A graphical user interface is also provided according to a sixth embodiment of the present disclosure. The graphical user interface can be used in the mobile terminal. The graphical user interface may include a touch-screen display, a memory and one or more processors to execute one or more programs, including:

acquiring current geographical location and time of a mobile terminal;

determining whether the current geographical location of the mobile terminal matches up to a geographic trigger location preset in a scheduled task;

determining whether the current time of the mobile terminal matches up to a trigger time in the scheduled task; and

triggering the mobile terminal to execute the scheduled task on condition that the current geographical location of the mobile terminal matches up to the trigger geographic location and the current time of the mobile terminal matches up to the trigger time of the scheduled task.

In a word, the graphical user interface provided by the present disclosure is configured to determine whether the current geographic location of the mobile terminal matches up to the trigger geographic location of the scheduled task, whether the current time of the mobile terminal matches up to the trigger time of the scheduled task, then to execute the scheduled task. It solves the complex problem that the user has to repeatedly set scheduled tasks in different locations and the mobile terminal can execute the scheduled task according to its current geographic location and time. Besides, the mobile terminal precisely matches the trigger time in accordance with the time difference of time zones between the trigger geographic location and the current geographic location of the user, which avoids the problem that an inaccurate trigger time caused by the time difference leads to an inaccurate trigger task.

To be sure, though the scheduled task execution devices in above embodiments are illustrated to execute the scheduled task in line with the function modules, if necessary the above functions can be assigned to different function modules, that is, the inner structure of the device can be divided into different function modules to complete some of or all above functions. Besides, the scheduled task execution devices, the mobile terminal and the scheduled task execution methods in above embodiments are belongs to the same design whose concrete realization process can be seen in the method embodiments and not be listed here.

The numbers of above embodiments of the present disclosure is only to illustrate but not mean their qualities.

Some of or all steps shown in the embodiments of the present invention can be achieved by software and corresponding software programs can be stored in the readable memory media such as CDs or hard drives, etc.

The above described are the preferred embodiments of the present invention only, and are not intended to limit the present invention, and any alterations, equivalent replacements and improvements that made without departing from the spirit and scope of the present invention are intended to fall in the scope of the present invention.

1. A method for executing scheduled tasks, comprising:
acquiring current geographical location and time of a mobile terminal;
determining whether the current geographical location of the mobile terminal matches up to a geographic trigger location preset in a scheduled task;
determining whether the current time of the mobile terminal matches up to a trigger time in the scheduled task; and
triggering the mobile terminal to execute the scheduled task on condition that the current geographical location of the mobile terminal matches up to the trigger geographic location and the current time of the mobile terminal matches up to the trigger time of the scheduled task.

2. The method according to claim 1, further comprising:
presetting the scheduled task before determining whether the current geographical location of the mobile terminal matches up to a geographic trigger location preset in a scheduled task and determining whether the current time of the mobile terminal matches up to a trigger time in the scheduled task; wherein the scheduled task includes the trigger geographic location, the trigger time and task content; wherein
triggering the mobile terminal to execute the scheduled task comprises: triggering the mobile terminal to execute the task content of the scheduled task.

3. The method according to claim 1, wherein determining whether the current time of the mobile terminal matches up to a trigger time in the scheduled task comprises:
judging whether the current time of the mobile terminal is the time in a time zone where the current geographic location of the mobile terminal is;
converting the current time of the mobile terminal to the time in the time zone where the current geographic location of the mobile terminal is on condition that the current time of the mobile terminal is not the time in a time zone where the current geographic location of the mobile terminal is; and
determining whether the current time after being converted matches up to a trigger time in the scheduled task.

4. The method according to claim 2, wherein the geographic trigger location is preset in the scheduled task by receiving a geographic location triggered by the user in a map provided in the mobile terminal, acquiring the trigger geographic location via text information input by the user, or acquiring the current geographic location of the mobile terminal.

5. The method according to claim 1, wherein acquiring the current geographical location of the mobile terminal comprises: acquiring the current geographic location of the user through at least one of: positioning by GPS, positioning through a gateway of WIFI, positioning through a gateway of the mobile network, and positioning through a base station of the mobile network.

6. A mobile terminal, comprising: a display, one or more processors, a memory and one or more programs, wherein the one or more programs are stored in the memory and to be executed by the one or more processors, the one or more programs comprise instructions of:
acquiring current geographical location and time of a mobile terminal;
determining whether the current geographical location of the mobile terminal matches up to a geographic trigger location preset in a scheduled task;
determining whether the current time of the mobile terminal matches up to a trigger time in the scheduled task; and
triggering the mobile terminal to execute the scheduled task on condition that the current geographical location of the mobile terminal matches up to the trigger geographic location and the current time of the mobile terminal matches up to the trigger time of the scheduled task.

7. The mobile terminal according to claim 6, wherein the one or more programs further comprises instructions of:
presetting the scheduled task; wherein the scheduled task includes the trigger geographic location, the trigger time and task content;
triggering the mobile terminal to execute the scheduled task comprises:
triggering the mobile terminal to execute the task content of the scheduled task.

8. The mobile terminal according to claim 6, wherein the one or more programs further comprises instructions of:
judging whether the current time of the mobile terminal is the time in a time zone where the current geographic location of the mobile terminal is;
converting the current time of the mobile terminal to the time in the time zone where the current geographic location of the mobile terminal is on condition that they are not the same;
determining whether the current time after being converted matches up to a trigger time in the scheduled task.

9. The mobile terminal according to claim 7, wherein the one or more programs further comprises instructions of: receiving a geographic location triggered by the user in a map provided in the mobile terminal, acquiring the trigger geographic location via text information input by the user, or acquiring the current geographic location of the mobile terminal.

10. The mobile terminal according to claim 6, wherein the one or more programs further comprises instructions of: acquiring the current geographic location of the user through at least one of: positioning by GPS, positioning through a gateway of WIFI, positioning through a gateway of the mobile network, and positioning through a base station of the mobile network.

11. A computer-readable storage medium, comprising one or more programs to be executed by one or more processors, wherein the one or more programs comprise instructions of:
acquiring current geographical location and time of a mobile terminal;
determining whether the current geographical location of the mobile terminal matches up to a geographic trigger location preset in a scheduled task;
determining whether the current time of the mobile terminal matches up to a trigger time in the scheduled task; and
triggering the mobile terminal to execute the scheduled task on condition that the current geographical location of the mobile terminal matches up to the trigger geographic location and the current time of the mobile terminal matches up to the trigger time of the scheduled task.

12. The computer-readable storage medium according to claim 11, wherein the one or more programs further comprises instructions of:
presetting the scheduled task; wherein the scheduled task includes the trigger geographic location, the trigger time and task content;
triggering the mobile terminal to execute the scheduled task comprises:
triggering the mobile terminal to execute the task content of the scheduled task.

13. The computer-readable storage medium according to claim 11, wherein determining whether the current time of the mobile terminal matches up to a trigger time in the scheduled task comprises:
judging whether the current time of the mobile terminal is the time in a time zone where the current geographic location of the mobile terminal is;
converting the current time of the mobile terminal to the time in the time zone where the current geographic location of the mobile terminal is on condition that they are not the same; and
determining whether the current time after being converted matches up to a trigger time in the scheduled task.

14. The computer-readable storage medium according to claim 13, wherein the geographic trigger location is preset in the scheduled task by receiving a geographic location triggered by the user in a map provided in the mobile terminal, acquiring the trigger geographic location via text information input by the user, or acquiring the current geographic location of the mobile terminal.

15. The computer-readable storage medium according to claim 11, wherein acquiring the current geographical location of the mobile terminal comprises: acquiring the current geographic location of the user through at least one of: positioning by GPS, positioning through a gateway of WIFI, positioning through a gateway of the mobile network, and positioning through a base station of the mobile network.
